(19) United States
(12) Patent Application Publication
(10) Pub. No.: US 2017/0285603 A1
(43) Pub. Date: Oct. 5, 2017

(54) COMMON ELECTRICAL BOX FORM FACTOR FOR SENSING TECHNOLOGIES

(71) Applicants: Dan H. Gerbus, Aloha, OR (US); Ralph V. Miele, Hillsboro, OR (US)

(72) Inventors: Dan H. Gerbus, Aloha, OR (US); Ralph V. Miele, Hillsboro, OR (US)

(21) Appl. No.: 15/088,750

(22) Filed: Apr. 1, 2016

(51) Int. Cl. G05B 19/042

(52) U.S. Cl. CPC G05B 19/0428; G05B 2219/25011

(57) ABSTRACT

A sensor system including a remote sensor and an integrated system on a chip (“SOC”) or controller. The remote sensor can be integrated into the light switch to monitor the area adjacent the light switch, where the light switch can visually disguise the remote sensor to minimize any undesirable aesthetic appearances created by the remote sensor. As light switches are ordinarily positioned high on a wall to be easily accessible, the concealed remote sensor also positioned to make optimal measurements of the area adjacent the light switch. The SOC can process measurements for the remote sensor and provide a control signal for an HVAC controller or other building system. The SOC can permit the sensor system to operate as a localized controller that can operate building systems to control conditions adjacent the sensor system.

### TECHNICAL FIELD

This document pertains generally, but not by way of limitation, to sensing technologies for building automation.

### BACKGROUND

Conventional building automation systems typically include a thermostat or controller that adjusts operation of HVAC or similar building systems to alter environmental or other conditions within a building. A sensor is often incorporated into the controller to monitor the environmental or other conditions within the building, wherein the controller adjusts operation of the building systems based on sensor measurements. Incorporating the sensor into the controller simplifies installation of the controller, but limits the portion of the building that can be monitored to the sensor to the area immediately adjacent to the controller. As such, the overall effectiveness of the controller is limited as portions of the building are unmonitored, which is result in undesirable conditions in the building as the controller adjusts the building systems based on incomplete information.

Sensors can be mounted remotely from the controller and operably connected to the controller to provide more complete monitoring of the building. However, remotely mounting sensors can complicate installation of the building automation system as the remote sensors must be connected to the controller. In particular, installing a building automation system with remote sensors into an existing building can require substantial remodeling, rewiring or other modifications to the building to operably link the remote sensors to the controller. A related drawback is that many sensor types can requiring specific positioning of the sensor to accurately monitor conditions within the space. For example, certain sensor types, such as temperature or humidity sensors, are typically mounted high on a wall or on the ceiling to accurately measure temperature or humidity. The positioning of the sensors improves the sensor measurements, but also increases the visibility of sensor, which can create an undesirable aesthetic appearance.

### BRIEF DESCRIPTION OF THE DRAWINGS

In the drawings, which are not necessarily drawn to scale, like numerals may describe similar components in different views. Like numerals having different letter suffixes may represent different instances of similar components. The drawings illustrate generally, by way of example, but not by way of limitation, various embodiments discussed in the present document.

FIG. 1 is an exploded perspective view of a sensor system with a light switch and a light switch cover according to an example of the present disclosure.

FIG. 2 is a partial cross-sectional perspective view of a sensor system assembled to a light switch and a light switch cover according to an example of the present disclosure.

FIG. 3 is a perspective view of the sensor system, light switch, and light switch cover assembly depicted in FIG. 2.

FIG. 4 is an exploded perspective view of the sensor system, light switch, and light switch cover assembly depicted in FIG. 2 being inserted into a gang box according to an example of the present disclosure.

FIG. 5 is a perspective view of a sensor system and light switch system assembly according to an example of the present disclosure.

FIG. 6 is a schematic view of a building control system having a sensor system for providing localized monitoring according to an example of the present disclosure.

FIG. 7 is a schematic view of a building control system having at least two sensor systems for providing localized monitoring according to an example of the present disclosure.

FIG. 8 is a schematic view of a building having a plurality of sensor systems for providing localized monitoring according to an example of the present disclosure.

### DETAILED DESCRIPTION

The present inventors have recognized, among other things, that a problem to be solved can include remote monitoring of areas throughout a building to accurately adjust building systems to provide desired building conditions. In an example, the present subject matter can provide a solution to this problem, such as by providing a sensor system that can be installed within a conventional gang box for a light switch or power receptacle. Using existing gang boxes permits mounting of the sensor system to the building structure without additional mounting brackets or other mounting features. The sensor system can be linked to the existing wiring for the gang box to power the sensor system without requiring additional wiring to be installed. The sensor system can be sized to be integrated into the gang box without displacing the original switch or receptacle in the gang box.

In an example, the sensor system can include a remote sensor and an integrated system on a chip (“SOC”) or controller. The remote sensor can be integrated into the light switch to monitor the area adjacent the light switch. The light switch can visually disguise the remote sensor to minimize any undesirable aesthetic appearances created by the remote sensor. As light switches are ordinarily positioned high on a wall to be easily accessible, the concealed remote sensor also positioned to make optimal measurements of the area adjacent the light switch.

In an example, the SOC can process measurements for the remote sensor and provide a control signal for an HVAC controller or other building system. The SOC can permit the sensor system to operate as a localized controller that can operate building systems to control conditions adjacent the sensor system. The SOC can monitor the temperature or other environmental conditions within a localized space and provide a control signal corresponding to the temperature or other environmental conditions measured within the localized space. The sensor system can be configured to perform optical recognition of objects or detect heat sources within the localized space. The SOC can recognize heat generating objects (e.g. persons, heaters) or other objects within the localized space that can alter the temperature or other environmental conditions. In an example, the sensor system can be configured to detect temperature or environmental condition gradients within the building.

In an example, each sensor system can communicate with other sensor systems to coordinate the operation of the building systems over the entirety of the building. An environmental condition monitored by a first SOC in a first localized space can be compared to the environmental conditions monitored by a second SOC in a second localized space. The building systems can be adjusted to equalize the environmental conditions if a difference is directed. Similarly, the plurality of SOCs can collectively determined if heat generating or other environmental condition affecting objects are moving throughout the building and between localized spaces. The building systems can be operated to vary the environmental conditions in the various localized spaces correspond to the movement of the objects through the building.

This overview is intended to provide an overview of subject matter of the present patent application. It is not intended to provide an exclusive or exhaustive explanation of the present subject matter. The detailed description is included to provide further information about the present patent application.

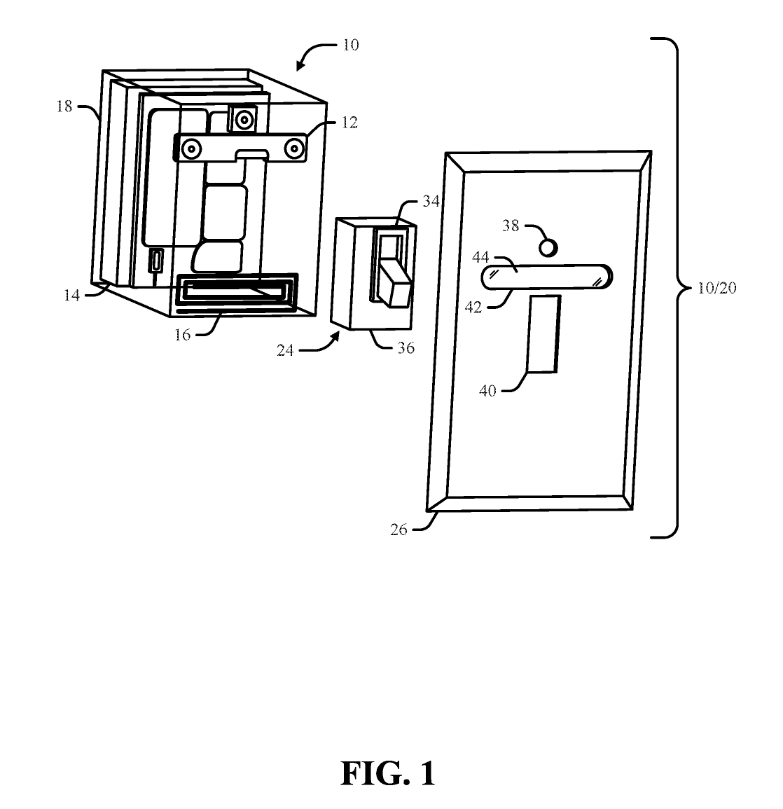

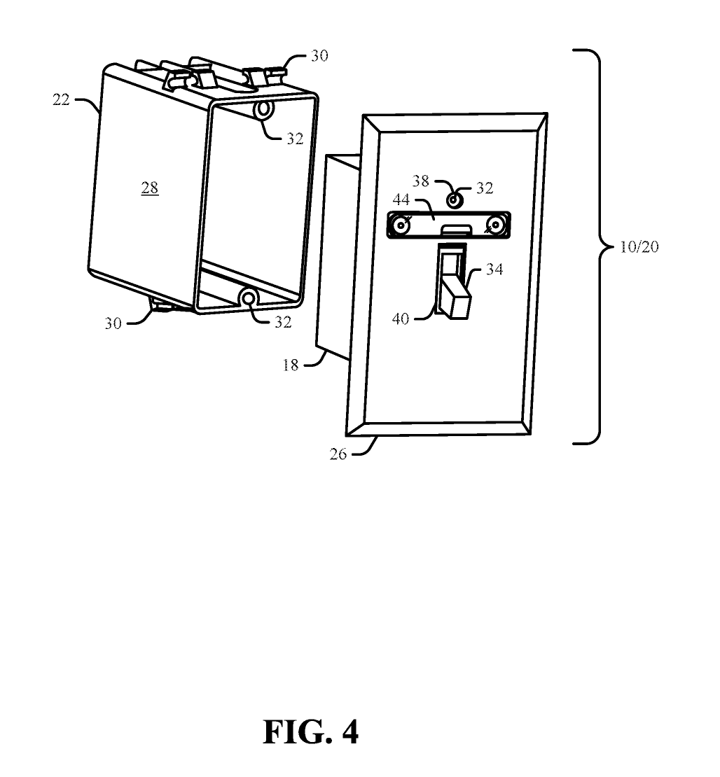

As depicted in FIGS. 1 and 4, a sensor system 10, according to an example of the present disclosure, can include a remote sensor 12 and an SOC 14. The remote sensor 12 can comprise an optical camera, a 3D camera, an infrared sensor, a temperature sensor, a humidity sensor, a barometric sensor, an air quality sensor, a particulate sensor, a motion sensor, a microphone, or combinations thereof. The SOC 14 can receive measurements from the remote sensor 12 and generate control signals based on the measurements according to predetermined algorithms. In an example, the sensor system 10 can include an antenna 16 for wirelessly transmitting control signals to a remote receiver for a building system.

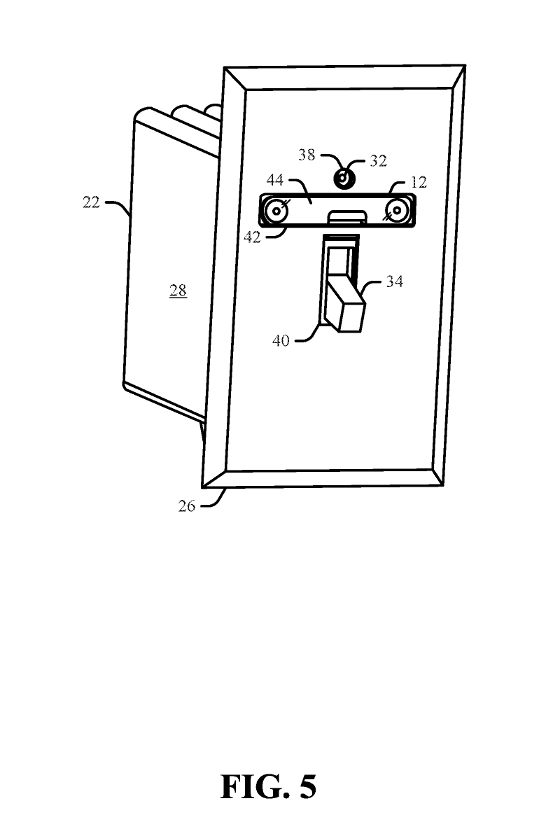

As depicted in FIGS. 4-5, the sensor system 10 can be integrated into a light switch system 20. The light switch system 20 can include a gang box 22, a light switch 24, and a light switch cover 26. As depicted in FIGS. 4-5, the light switch system 20 comprises a single light switch 24, but can be sized and arranged to incorporate multiple light switches Similarly, a power plug system can be mounted within the gang box 22 in place or in addition to the light switch system 20. In an example, the power plug system can include at least one transformer and at least one switch received within the gang box 22. The power plug system can include at least one power outlet for receiving a power plug of electronic device to link the electronic device to the building power supply. A power plug cover can include at least one opening positioned to correspond to a corresponding power outlet of the power plug cover.

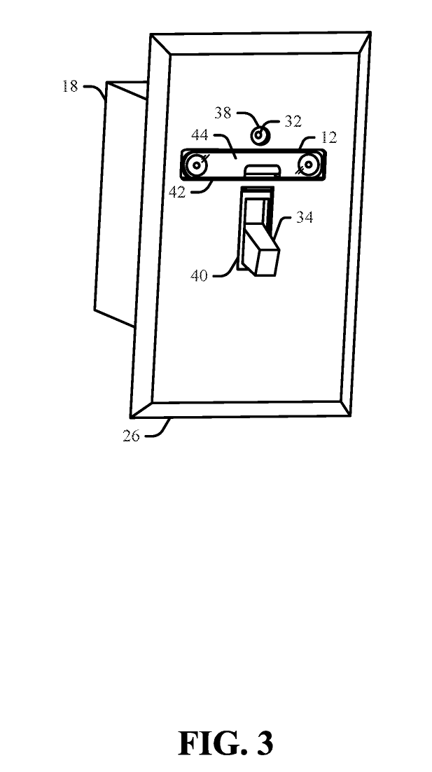

Referring to FIG. 3, in an example, the gang box 22 can include an exterior wall 28 defining an enclosed space and an opening for receiving the light switch 24 into the enclosed space. The exterior wall 28 can include at least one mounting feature 30 for receiving a fastener or otherwise mounting the gang box 22 to a wall stud, wall surface or other support structure. The exterior wall 28 can include at least one internal feature 32 for receiving a fastener for coupling the light switch 24, the light switch cover 26 or both to the gang box 22. In an example, the wiring can be coupled to the gang box 22 or inserted through an opening in the gang box 22 to couple the light switch 24 to the wiring. The wiring can be connected to building systems including, but not limited to, lighting, air fans, motorized windows or blinds, motorized doors or other selectively controlled electronic systems.

The light switch 24 can include a switch feature 34 and a switch box 36. As depicted in FIGS. 1-5, the switch feature 34 is a conventional toggle switch, but can comprise a push button, a dimmer switch, a slider switch, a touch screen, a button switch, and other conventional switch types. The switch box 36 can be operably connected to the building wiring such that operation of the switch feature 34 selectively operates lighting and other building features. In an example, the switch box 36 can include a mounting feature for receiving a fastener for mounting the light switch 24 to the gang box 22. The light switch 24 can be coupled to the gang box 22 such that the switch box 36 is at least partially positioned within the gang box 22 and the switch feature 34 protrudes from the opening defined by the exterior wall 28.

The light switch cover 26 can define a mounting opening 38 and at least one switch opening 40. The mounting opening 38 can receive a fastener for coupling the light switch cover 26 to the gang box 22 to enclose the enclosed space defined by the enclosed space. The switch opening 40 can be sized such that the switch feature 34 extends through the light switch cover 26.

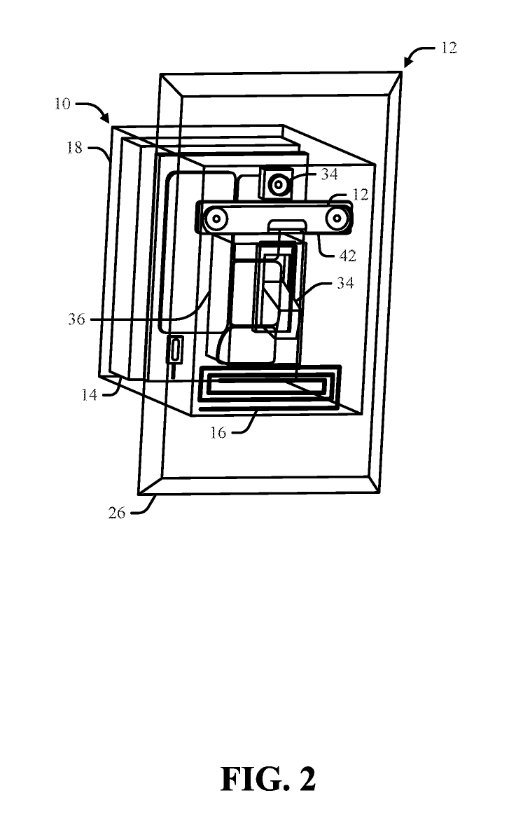

As depicted in FIGS. 4-5, the sensor system 10 can be mounted within the enclosed space of the gang box 22. The SOC 14 can be coupled to the gang box 22 and operably connected to the wiring connected to the gang box 22 to power the SOC 14. The remote sensor 12 can be coupled to the light switch cover 26 to collect measurements through the light switch cover 26. In an example, the light switch cover 26 can define a remote sensor port 42 for collecting measurements through the light switch cover 26. The switch cover 26 can include a transparent or semi-transparent window pane 44 for preventing contaminants from contacting the remote sensor 12 or entering the space enclosed by the gang box 22 and the light switch cover 26. In an example, the antenna 16 can be coupled to the light switch cover 26 as depicted in FIGS. 1-2.

In an example, the sensor system 10 can include a sensor housing 18 containing the SOC 14 and the remote sensor 12. The sensor housing 18 can be inserted through the opening of the gang box 22 into the enclosed space. In this configuration, the sensor system 10 can be installed within the gang box 22 as a drop-in module. In this configuration, the sensor housing 18 can be sized to approximate the inner dimensions of the exterior wall 28. The light switch 24 can be at least partially received within the sensor housing 18.

During installation, the sensor system 10 can be integrated into the light switch system 20 prior to mounting of the light switch system 20 into a wall such that the light switch system 20 can be mounted within the wall with a pre-installed remote sensor 12. Alternatively, the sensor system 10 can be integrated into the light switch system 20 after mounting into the wall to retrofit the light switch system 20 with a remote sensor 12.

The SOC 14 can be mounted to the gang box 22. In an example, the SOC 14 can be mounted to the exterior wall 28 at the rear of the gang box 22 or the side of the gang box 22 to maximize the size of the enclosed space. In a pre-mounted light switch system 20, the switch cover 26 can be removed and the light switch 24 is removed from the gang box 22 prior to mounting the SOC 14 within the gang box 22. The light switch 24 can be mounted or re-mounted to the gang box 22 to position the switch box 36 partially within the enclosed space adjacent the SOC 14.

The remote sensor 12 can be coupled to the light switch cover 26 prior to mounting or re-mounting of the light switch cover 26 onto the gang box 22. In an example, for pre-mounted light switch system 20, the original light switch cover 26 can be replaced with a light switch cover 26 defining a remote sensor port 42. In this configuration, the remote sensor 12 can be coupled to the light switch cover 26 such that the remote sensor 26 can be mounted to the light switch cover 26 to make measurements through the light switch cover 26.

The antenna 16 can be coupled to the light switch cover 26 prior to mounting or re-mounting of the light switch cover 26 onto the gang box 22. In an example, for pre-mounted light switch system 20, the original light switch cover 26 can be replaced with a light switch cover 26 defining a remote sensor port 42. In this configuration, the antenna 16 can be mounted to the replacement light switch cover 26 to reconfigure the light switch system 20 for a remote sensor 26.

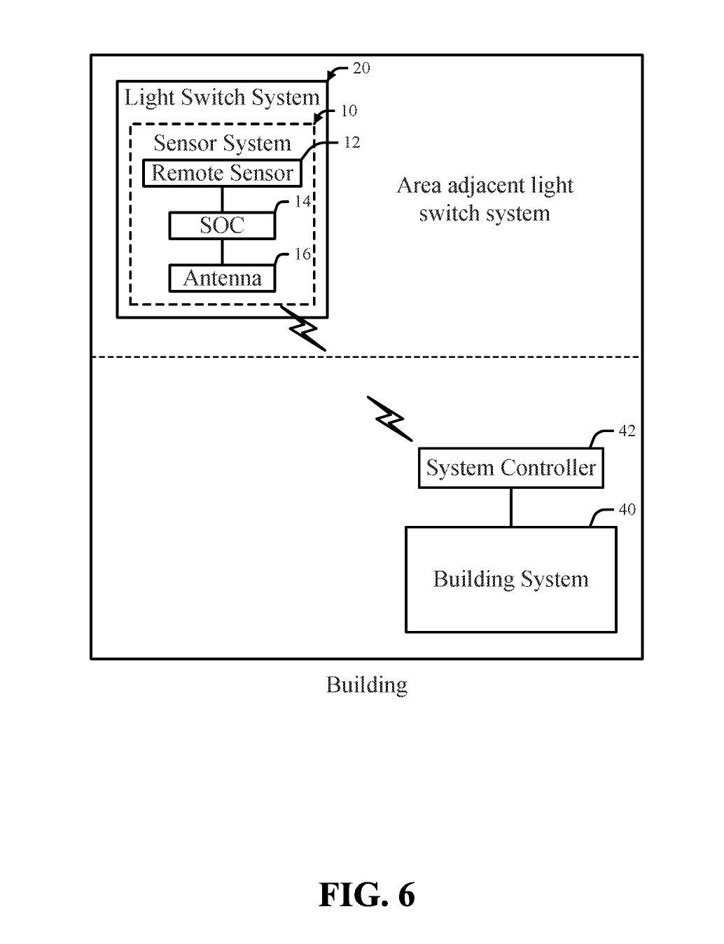

As depicted in FIG. 6, in operation, the remote sensor 12 of the integrated sensor system 10 can monitor the area adjacent the light switch system 20 and make at least one measurement. The measurement can include, but is not limited to temperature, humidity, air flow, motion detection, occupancy, number of occupants, auditory measurements, air quality, or combinations thereof. The SOC 14 can process the at least one measurement and generate at least one control signal that can be transmitted to a remote system controller 42 for a building system 40 via the antenna 16. The building system 40 can include, but is not limited to ventilation, heating, cooling, lighting, security, occupancy monitoring, air quality, humidity, or combinations thereof. The system controller 42 can operate the building system 40 to provide a desired localized effect proximate the light switch system 20.

In an example, the remote sensor 12 can collect at least two measurements of different types such that the SOC 14 can generate a multi-measurement control signal that accounts for the measurement types. For example, the remote sensor 12 can measure the air temperature in the area adjacent the light switch system 20 and determine the number of occupants in the area. The SOC 14 can provide a multi-measurement control signal that will vary the air temperature in the area to a desired temperature while accounting for the approximate heat generated by the occupants. In another example, the remote sensor 12 can measure an auditory level exceeding a predetermined threshold, such as from a waking child, and measure the air temperature in the area adjacent the light switch system 20. The SOC 14 can provide a multi-measurement control signal that will vary the air temperature in the area to a desired temperature and monitor auditory responses from the child, such as those indicative of a child returning to sleep.

In an example, the remote sensor 12 can include at least an optical sensor and at least an environmental sensor. In this configuration, the remote sensor 12 can be configured to determine if heat generating objects (e.g. human bodies, heat generating electronics) are present within the area adjacent the sensor system 10. The optical sensor can also collect information on the heat generating object(s) including, but not limited to the number of objects, the relative positions of the objects, the timing of heat generation by the objects, the intensity of the heat generated by the objects, and other information. In at least one example, the information gathered by the optical sensor regarding the heat generating objects can be incorporated into with the environmental measurements gathered by the environmental sensor by the SOC 14 such that the calculated control signal incorporates environmental information from the environmental sensor and information on the heat generating objects from the optical sensors.

In an example, the SOC 14 can monitor changes in the environment adjacent the remote sensor 10 with the environmental sensor (e.g. temperature gradients) while determining if the changes in the environment are the result of normal changes or the presence of heat generating objects detected by the optical sensor. The SOC 14 can determine the effect on the measured transition based due to the presence of heat generating objects and generate a profile of the changing environmental conditions such as a temperature gradient. The SOC 14 can send a control signal to the remote system controller 42 for the building system 40 such that building system 40 is operated based on the detected on the presence of heat generating objects.

In an example, each remote sensor 12 can continually monitor the space for information that could be used to operate building systems. The space information can include object detection and image analysis to gather information pertaining to persons within the space including, but are not limited to whether the space is occupied, whether the space has been vacated, the number of occupants, whether the occupants are moving, or combinations thereof. The each remote sensor 12 can monitor the space for information at regular intervals and determine if there are changes in the space. For example, the each remote sensor 12 can determine if a person within the space has not moved during the interval between measurements of the each remote sensor 12 or has left the space. The space information can also include information pertaining to various environmental conditions to determine if the occupants or other objects are affecting environmental conditions within the space.

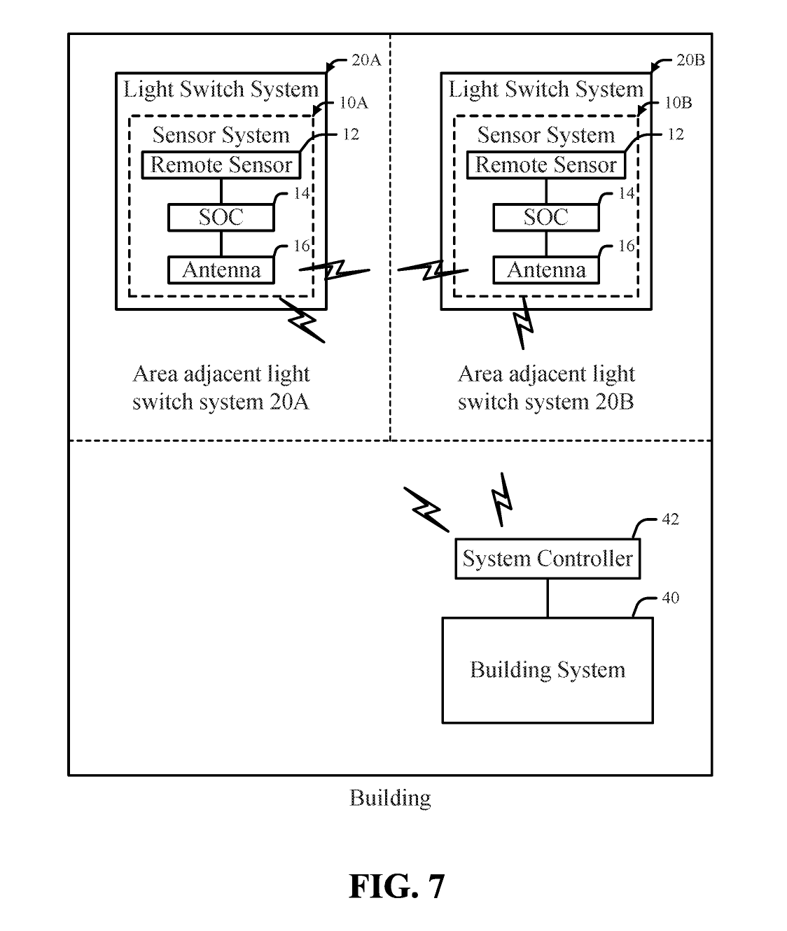

As depicted in FIG. 7, in an example, a first sensor system 10A can coordinate with at least a second sensor system 10B to provide a single joint control signal that provide desired localized effects proximate the corresponding lighting witch systems 20A, 20B. Alternatively, the joint control signal can operate the building system 40 to provide an averaged effect in the areas proximate the corresponding lighting witch systems 20A, 20B.

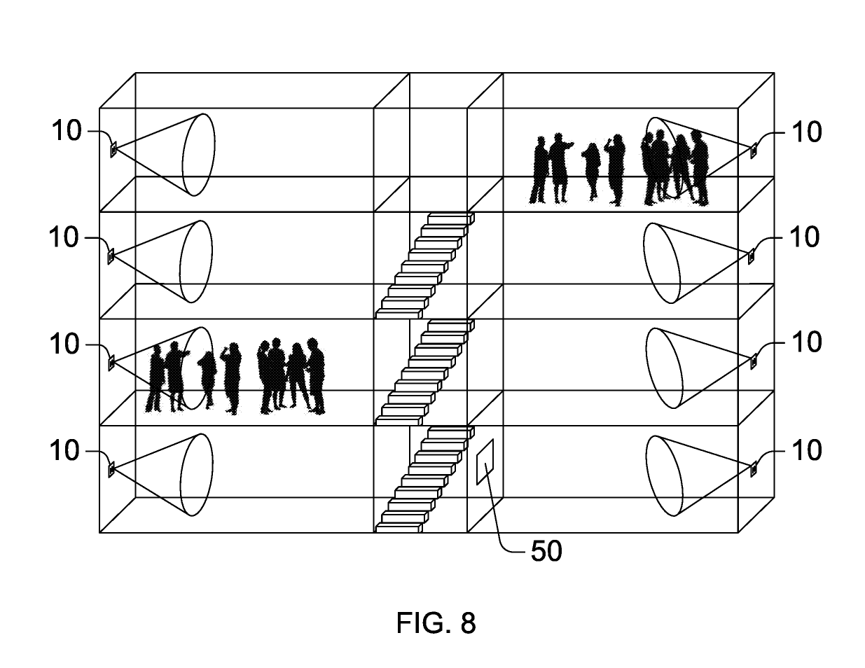

As depicted in FIG. 8, a plurality of sensor systems 10 can be positioned throughout a building, each sensor system 10 configured to monitor a different localized space for different space information. The SOC 14 can receive space information from each remote sensor 12 and communicate the space information to a central controller 50 or a single sensor system 10 acting as a central controller for the plurality of sensor systems 10. In this configuration, the plurality of sensor systems 10 can track the movement of objects (e.g. persons) throughout a building or detect the presence of objects that affect environmental conditions. In an example, the central controller 50 can vary environmental conditions throughout the building according to the position of objects within the building.

### VARIOUS NOTES & EXAMPLES

Example 1 is a sensor system for a building, comprising: a remote sensor configured to take at least one measurement within an area of the building; and a system on a chip (“SOC”) configured to receive the at least one measurement from the remote sensor; wherein the SOC is configured to calculate at least one control signal based on the at least one measurement from the remote sensor.

In Example 2, the subject matter of Example 1 optionally includes wherein the remote sensor comprises an optical camera, a 3D camera, an infrared sensor, a temperature sensor, a humidity sensor, a barometric sensor, an air quality sensor, a particulate sensor, a motion sensor, a microphone, or combinations thereof.

In Example 3, the subject matter of Example 2 optionally includes wherein the remote sensor comprises: a first sensor configured to take at least one first measurement of a first type; a second sensor configured to take at least one second measurement of a second type; and wherein the first type is different from the second type such that at least two types of measurements are made by the remote sensor.

In Example 4, the subject matter of Example 3 optionally includes wherein the SOC calculates the at least one control signal based on the at least one first measurement and the at least one second measurement.

In Example 5, the subject matter of any one or more of Examples 1-4 optionally include wherein the system includes an antenna operably coupled to the SOC for wirelessly transmitting the at least one control signal.

In Example 6, the subject matter of Example 5 optionally includes wherein the antenna is configured to transmit the at least one control signal to a system controller for a building system.

In Example 7, the subject matter of Example 6 optionally includes wherein the building system comprises ventilation, heating, cooling, lighting, security, occupancy monitoring, air quality, humidity, or combinations thereof.

In Example 8, the subject matter of any one or more of Examples 5-7 optionally include at least one second sensor system comprising a second remote sensor configured to take at least one second measurement in a second area.

In Example 9, the subject matter of Example 8 optionally includes wherein the antenna is configured to transmit the at least one measurement from the remote sensor to the second sensor system and receive the at least one second measurement from the second sensor system.

In Example 10, the subject matter of Example 9 optionally includes wherein the SOC calculates the at least one control signal based on the at least one measurement from the remote sensor and the at least one second measurement from the second remote sensor of the sensor system.

In Example 11, the subject matter of any one or more of Examples 1-10 optionally include wherein the SOC is wired to a system controller for a building system for transmitting the at least one control signal to the system controller.

In Example 12, the subject matter of any one or more of Examples 1-11 optionally include a gang box having an exterior wall defining an enclosed space and an opening through the exterior wall for accessing the enclosed space; a light switch having a switch feature and a switch box, the light switch being positioned within the opening such that the switch box is positioned within the enclosed space and the switch feature protrudes from the opening; and a light switch cover mountable to the gang box to cover the opening.

In Example 13, the subject matter of Example 12 optionally includes a sensor housing; wherein the SOC is couplable within the sensor housing.

In Example 14, the subject matter of Example 13 optionally includes wherein the sensor housing is insertable into the enclosed space through the opening: wherein the switch box is positioned within the sensor housing.

In Example 15, the subject matter of any one or more of Examples 12-14 optionally include wherein the exterior wall includes at least one mounting feature for mounting the gang box to a support structure.

In Example 16, the subject matter of any one or more of Examples 12-15 optionally include wherein the exterior wall includes at least one internal feature for receiving a fastener for coupling at least one of the light switch and the light switch cover.

In Example 17, the subject matter of Example 16 optionally includes wherein the light switch cover defines at least one mounting opening such that the fastener is insertable through the mounting opening into engagement with the at least one internal feature.

In Example 18, the subject matter of any one or more of Examples 12-17 optionally include wherein the gang box defines an opening through which wiring is insertable to operably couple the light switch box to the wiring.

In Example 19, the subject matter of Example 18 optionally includes wherein the SOC is positionable within the enclosed space such that the SOC is couplable to the wiring; wherein the remote sensor is operably coupled to the SOC such that the SOC powers the remote sensor.

In Example 20, the subject matter of Example 19 optionally includes wherein the SOC is coupled to a rear face of the exterior wall.

In Example 21, the subject matter of any one or more of Examples 12-20 optionally include wherein the switch feature is selected from a group consisting of a conventional toggle switch, but can comprise a push button, a dimmer switch, a slider switch, a touch screen, and a button switch.

In Example 22, the subject matter of Example 21 optionally includes the light switch cover defines one switch opening through which the switch feature extends through the switch opening.

In Example 23, the subject matter of any one or more of Examples 12-22 optionally include wherein the light switch cover defines at least one remote sensor port; wherein the remote sensor is coupled to the light switch cover adjacent to the remote sensor port.

In Example 24, the subject matter of Example 23 optionally includes a semi-transparent window pane positioned within the remote sensor port preventing contaminants from entering the enclosed space.

In Example 25, the subject matter of any one or more of Examples 12-24 optionally include wherein the antenna is mounted to the light switch cover.

Example 26 is a method for monitoring a building, the method comprising: positioning a remote sensor within an area of the building; taking at least one measurement with the remote sensor; receiving the at least one measurement from the remote sensor with a SOC; and calculating at least one control signal with the SOC based on the at least one measurement from the remote sensor.

In Example 27, the subject matter of Example 26 optionally includes wherein the remote sensor comprises an optical camera, a 3D camera, an infrared sensor, a temperature sensor, a humidity sensor, a barometric sensor, an air quality sensor, a particulate sensor, a motion sensor, a microphone, or combinations thereof.

In Example 28, the subject matter of Example 27 optionally includes taking at least one first measurement of a first type with a first sensor; and taking at least one second measurement of a second type with a second sensor.

In Example 29, the subject matter of Example 28 optionally includes receiving the at least one first measurement from the first sensor and the at least one second measurement from the second sensor with the SOC; and calculating at least one control signal with the SOC based on the at least one first measurement and the at least one second measurement.

In Example 30, the subject matter of any one or more of Examples 26-29 optionally include coupling an antenna to the SOC; and transmitting the at least one control signal.

In Example 31, the subject matter of Example 30 optionally includes wherein the at least one control signal is transmitted to a system controller for a building system.

In Example 32, the subject matter of Example 31 optionally includes wherein the building system comprises ventilation, heating, cooling, lighting, security, occupancy monitoring, air quality, humidity, or combinations thereof. In Example 33, the subject matter of any one or more of Examples 26-32 optionally include positioning a second remote sensor of a second sensor system within a second area of the building; and taking at least one second measurement with the second remote sensor.

In Example 34, the subject matter of Example 33 optionally includes transmitting the at least one measurement from the remote sensor to the second sensor system; and receiving the at least one second measurement from the second sensor system with the SOC.

In Example 35, the subject matter of Example 34 optionally includes calculating at least one control signal with the SOC based on the at least one measurement from the remote sensor and the at least one second measurement from the second remote sensor.

In Example 36, the subject matter of any one or more of Examples 26-35 optionally include wiring the SOC to a system controller for a building system for transmitting the at least one control signal to the system controller.

In Example 37, the subject matter of any one or more of Examples 26-36 optionally include providing a gang box having an exterior wall defining an enclosed space and an opening through the exterior wall for accessing the enclosed space; and positioning a light switch having a switch feature and a switch box at least partially within the enclosed space through the opening such that the switch feature protrudes from the opening.

In Example 38, the subject matter of Example 37 optionally includes coupling the SOC within a sensor housing.

In Example 39, the subject matter of Example 38 optionally includes inserting the sensor housing through the opening into the enclosed space; and positioning the switch box within the sensor housing.

In Example 40, the subject matter of any one or more of Examples 37-39 optionally include engaging the at least one mounting feature of the exterior wall to a support structure to mount the gang box to the support structure.

In Example 41, the subject matter of any one or more of Examples 37-40 optionally include engaging a fastener to at least one internal feature to couple at least one of the light switch and the light switch cover.

In Example 42, the subject matter of Example 41 optionally includes wherein the light switch cover defines at least one mounting opening such that the fastener is insertable through the mounting opening into engagement with the at least one internal feature.

In Example 43, the subject matter of any one or more of Examples 37-42 optionally include inserting wiring through an opening in the gang box; and coupling the wiring to the light switch.

In Example 44, the subject matter of Example 43 optionally includes positioning the SOC within the enclosed space; coupling the wiring to the SOC; and coupling the remote sensor to the SOC such that the SOC powers the remote sensor.

In Example 45, the subject matter of Example 44 optionally includes coupling the SOC to a rear face of the exterior wall.

In Example 46, the subject matter of any one or more of Examples 37-45 optionally include wherein the switch feature is selected from a group consisting of a conventional toggle switch, but can comprise a push button, a dimmer switch, a slider switch, a touch screen, and a button switch.

In Example 47, the subject matter of Example 46 optionally includes mounting the light switch cover to the gang box such that the switch feature extends through the switch opening.

In Example 48, the subject matter of any one or more of Examples 37-47 optionally include coupling the remote sensor to the light switch cover such that the remote sensor is positioned adjacent to at least one remote sensor port defined by the light switch cover.

In Example 49, the subject matter of Example 48 optionally includes positioning a semi-transparent window pane within the remote sensor port preventing contaminants from entering the enclosed space.

In Example 50, the subject matter of any one or more of Examples 37-49 optionally include mounting the antenna to the light switch cover.

Example 51 is an apparatus comprising means for performing any of the methods of Examples 26-50.

Example 52 is at least one machine-readable medium including instructions, which when executed by a machine, cause the machine to perform operations of any of the methods of Examples 26-50.

Example 53 is an apparatus for monitoring a building, the method comprising: means for positioning a remote sensor within an area of the building; means for taking at least one measurement with the remote sensor; means for receiving the at least one measurement from the remote sensor with a SOC; and means for calculating at least one control signal with the SOC based on the at least one measurement from the remote sensor.

In Example 54, the subject matter of Example 53 optionally includes wherein the remote sensor comprises an optical camera, a 3D camera, an infrared sensor, a temperature sensor, a humidity sensor, a barometric sensor, an air quality sensor, a particulate sensor, a motion sensor, a microphone, or combinations thereof.

In Example 55, the subject matter of Example 54 optionally includes means for taking at least one first measurement of a first type with a first sensor; and means for taking at least one second measurement of a second type with a second sensor.

In Example 56, the subject matter of Example 55 optionally includes means for receiving the at least one first measurement from the first sensor and the at least one second measurement from the second sensor with the SOC; and means for calculating at least one control signal with the SOC based on the at least one first measurement and the at least one second measurement.

In Example 57, the subject matter of any one or more of Examples 53-56 optionally include means for coupling an antenna to the SOC; and means for transmitting the at least one control signal.

In Example 58, the subject matter of Example 57 optionally includes wherein the at least one control signal is transmitted to a system controller for a building system.

In Example 59, the subject matter of Example 58 optionally includes wherein the building system comprises ventilation, heating, cooling, lighting, security, occupancy monitoring, air quality, humidity, or combinations thereof.

In Example 60, the subject matter of any one or more of Examples 53-59 optionally include means for positioning a second remote sensor of a second sensor system within a second area of the building; and means for taking at least one second measurement with the second remote sensor.

In Example 61, the subject matter of Example 60 optionally includes means for transmitting the at least one measurement from the remote sensor to the second sensor system; and means for receiving the at least one second measurement from the second sensor system with the SOC.

In Example 62, the subject matter of Example 61 optionally includes means for calculating at least one control signal with the SOC based on the at least one measurement from the remote sensor and the at least one second measurement from the second remote sensor.

In Example 63, the subject matter of any one or more of Examples 53-62 optionally include means for wiring the SOC to a system controller for a building system for transmitting the at least one control signal to the system controller.

In Example 64, the subject matter of any one or more of Examples 53-63 optionally include means for providing a gang box having an exterior wall defining an enclosed space and an opening through the exterior wall for accessing the enclosed space; and means for positioning a light switch having a switch feature and a switch box at least partially within the enclosed space through the opening such that the switch feature protrudes from the opening.

In Example 65, the subject matter of Example 64 optionally includes means for coupling the SOC within a sensor housing.

In Example 66, the subject matter of Example 65 optionally includes means for inserting the sensor housing through the opening into the enclosed space; and means for positioning the switch box within the sensor housing.

In Example 67, the subject matter of any one or more of Examples 64-66 optionally include means for engaging the at least one mounting feature of the exterior wall to a support structure to mount the gang box to the support structure.

In Example 68, the subject matter of any one or more of Examples 64-67 optionally include means for engaging a fastener to at least one internal feature to couple at least one of the light switch and the light switch cover.

In Example 69, the subject matter of Example 68 optionally includes wherein the light switch cover defines at least one mounting opening such that the fastener is insertable through the mounting opening into engagement with the at least one internal feature.

In Example 70, the subject matter of any one or more of Examples 64-69 optionally include means for inserting wiring through an opening in the gang box; and means for coupling the wiring to the light switch.

In Example 71, the subject matter of Example 70 optionally includes means for positioning the SOC within the enclosed space; means for coupling the wiring to the SOC; and means for coupling the remote sensor to the SOC such that the SOC powers the remote sensor.

In Example 72, the subject matter of Example 71 optionally includes means for coupling the SOC to a rear face of the exterior wall.

In Example 73, the subject matter of any one or more of Examples 64-72 optionally include wherein the switch feature is selected from a group consisting of a conventional toggle switch, but can comprise a push button, a dimmer switch, a slider switch, a touch screen, and a button switch.

In Example 74, the subject matter of Example 73 optionally includes means for mounting the light switch cover to the gang box such that the switch feature extends through the switch opening.

In Example 75, the subject matter of any one or more of Examples 64-74 optionally include means for coupling the remote sensor to the light switch cover such that the remote sensor is positioned adjacent to at least one remote sensor port defined by the light switch cover.

In Example 76, the subject matter of Example 75 optionally includes means for positioning a semi-transparent window pane within the remote sensor port preventing contaminants from entering the enclosed space.

In Example 77, the subject matter of any one or more of Examples 64-76 optionally include means for mounting the antenna to the light switch cover.

Example 78 is a sensor system for a building, comprising: a remote sensor configured to take at least one measurement within an area of the building; a system on a chip (“SOC”) configured to receive the at least one measurement from the remote sensor; and a controller configured to read computer readable instructions and configured to control operation of the sensor system, wherein the instructions for controlling operation of the sensor system comprises instructions for: receiving the at least one measurement from the remote sensor with a SOC; and calculating at least one control signal with the SOC based on the at least one measurement from the remote sensor.

In Example 79, the subject matter of Example 78 optionally includes wherein the remote sensor comprises an optical camera, a 3D camera, an infrared sensor, a temperature sensor, a humidity sensor, a barometric sensor, an air quality sensor, a particulate sensor, a motion sensor, a microphone, or combinations thereof.

In Example 80, the subject matter of Example 79 optionally includes wherein the instructions for controlling operation of the sensor system comprises instructions for: taking at least one first measurement of a first type with a first sensor; and taking at least one second measurement of a second type with a second sensor.

In Example 81, the subject matter of Example 80 optionally includes wherein the instructions for controlling operation of the sensor system comprises instructions for: receiving the at least one first measurement from the first sensor and the at least one second measurement from the second sensor with the SOC; and calculating at least one control signal with the SOC based on the at least one first measurement and the at least one second measurement.

In Example 82, the subject matter of any one or more of Examples 78-81 optionally include wherein the system includes an antenna operably coupled to the SOC for wirelessly transmitting the at least one control signal.

In Example 83, the subject matter of Example 82 optionally includes wherein the antenna is configured to transmit the at least one control signal to a system controller for a building system.

In Example 84, the subject matter of Example 83 optionally includes wherein the building system comprises ventilation, heating, cooling, lighting, security, occupancy monitoring, air quality, humidity, or combinations thereof.

In Example 85, the subject matter of Example 84 optionally includes at least one second sensor system comprising a second remote sensor configured to take at least one second measurement in a second area.

In Example 86, the subject matter of Example 85 optionally includes an antenna coupled to the SOC; wherein the instructions for controlling operation of the sensor system comprises instructions for transmitting the at least one control signal.

In Example 87, the subject matter of Example 86 optionally includes wherein the instructions for controlling operation of the sensor system comprises calculating at least one control signal with the SOC based on the at least one measurement from the remote sensor and the at least one second measurement from the second remote sensor.

In Example 88, the subject matter of any one or more of Examples 78-87 optionally include wherein the SOC is wired to a system controller for a building system for transmitting the at least one control signal to the system controller.

In Example 89, the subject matter of any one or more of Examples 78-88 optionally include a gang box having an exterior wall defining an enclosed space and an opening through the exterior wall for accessing the enclosed space; a light switch having a switch feature and a switch box, the light switch being positioned within the opening such that the switch box is positioned within the enclosed space and the switch feature protrudes from the opening; and a light switch cover mountable to the gang box to cover the opening.

In Example 90, the subject matter of Example 89 optionally includes a sensor housing; wherein the SOC is couplable within the sensor housing.

In Example 91, the subject matter of any one or more of Examples 89-90 optionally include wherein the sensor housing is insertable into the enclosed space through the opening: wherein the switch box is positioned within the sensor housing.

In Example 92, the subject matter of any one or more of Examples 89-91 optionally include wherein the exterior wall includes at least one mounting feature for mounting the gang box to a support structure.

In Example 93, the subject matter of any one or more of Examples 89-92 optionally include wherein the exterior wall includes at least one internal feature for receiving a fastener for coupling at least one of the light switch and the light switch cover.

In Example 94, the subject matter of Example 93 optionally includes wherein the light switch cover defines at least one mounting opening such that the fastener is insertable through the mounting opening into engagement with the at least one internal feature.

In Example 95, the subject matter of any one or more of Examples 89-94 optionally include wherein the gang box defines an opening through which wiring is insertable to operably couple the light switch box to the wiring.

In Example 96, the subject matter of Example 95 optionally includes wherein the SOC is positionable within the enclosed space such that the SOC is couplable to the wiring; wherein the remote sensor is operably coupled to the SOC such that the SOC powers the remote sensor.

In Example 97, the subject matter of Example 96 optionally includes wherein the SOC is coupled to a rear face of the exterior wall.

In Example 98, the subject matter of Example 97 optionally includes wherein the switch feature is selected comprising at least one of a conventional toggle switch, but can comprise a push button, a dimmer switch, a slider switch, a touch screen, and a button switch.

In Example 99, the subject matter of Example 98 optionally includes the light switch cover defines one switch opening through which the switch feature extends through the switch opening.

In Example 100, the subject matter of any one or more of Examples 89-99 optionally include wherein the light switch cover defines at least one remote sensor port; wherein the remote sensor is coupled to the light switch cover adjacent to the remote sensor port.

In Example 101, the subject matter of Example 100 optionally includes a semi-transparent window pane positioned within the remote sensor port preventing contaminants from entering the enclosed space.

In Example 102, the subject matter of any one or more of Examples 89-101 optionally include wherein the antenna is mounted to the light switch cover.

The above detailed description includes references to the accompanying drawings, which form a part of the detailed description. The drawings show, by way of illustration, specific embodiments in which the present subject matter can be practiced. These embodiments are also referred to herein as “examples.” Such examples can include elements in addition to those shown or described. However, the present inventors also contemplate examples in which only those elements shown or described are provided. Moreover, the present inventors also contemplate examples using any combination or permutation of those elements shown or described (or one or more aspects thereof), either with respect to a particular example (or one or more aspects thereof), or with respect to other examples (or one or more aspects thereof) shown or described herein.

In the event of inconsistent usages between this document and any documents so incorporated by reference, the usage in this document controls.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In this document, the terms “including” and “in which” are used as the plain-English equivalents of the respective terms “comprising” and “wherein.” Also, in the following claims, the terms “including” and “comprising” are open-ended, that is, a system, device, article, composition, formulation, or process that includes elements in addition to those listed after such a term in a claim are still deemed to fall within the scope of that claim. Moreover, in the following claims, the terms “first,” “second,” and “third,” etc. are used merely as labels, and are not intended to impose numerical requirements on their objects.

Method examples described herein can be machine or computer-implemented at least in part. Some examples can include a computer-readable medium or machine-readable medium encoded with instructions operable to configure an electronic device to perform methods as described in the above examples. An implementation of such methods can include code, such as microcode, assembly language code, a higher-level language code, or the like. Such code can include computer readable instructions for performing various methods. The code may form portions of computer program products. Further, in an example, the code can be tangibly stored on one or more volatile, non-transitory, or non-volatile tangible computer-readable media, such as during execution or at other times. Examples of these tangible computer-readable media can include, but are not limited to, hard disks, removable magnetic disks, removable optical disks (e.g., compact disks and digital video disks), magnetic cassettes, memory cards or sticks, random access memories (RAMs), read only memories (ROMs), and the like.

The above description is intended to be illustrative, and not restrictive. For example, the above-described examples (or one or more aspects thereof) may be used in combination with each other. Other embodiments can be used, such as by one of ordinary skill in the art upon reviewing the above description. The Abstract is provided to comply with 37 C.F.R. §1.72(b), to allow the reader to quickly ascertain the nature of the technical disclosure. It is submitted with the understanding that it will not be used to interpret or limit the scope or meaning of the claims. Also, in the above Detailed Description, various features may be grouped together to streamline the disclosure. This should not be interpreted as intending that an unclaimed disclosed feature is essential to any claim. Rather, inventive subject matter may lie in less than all features of a particular disclosed embodiment. Thus, the following claims are hereby incorporated into the Detailed Description as examples or embodiments, with each claim standing on its own as a separate embodiment, and it is contemplated that such embodiments can be combined with each other in various combinations or permutations. The scope of the present subject matter should be determined with reference to the appended claims, along with the full scope of equivalents to which such claims are entitled.

What is claimed is:

1. A sensor system for a building, comprising:
a remote sensor configured to take at least one measurement within an area of the building; and
a system on a chip (“SOC”) configured to receive the at least one measurement from the remote sensor;
wherein the SOC is configured to calculate at least one control signal based on the at least one measurement from the remote sensor.

2. The sensor system of claim 1, wherein the remote sensor comprises an optical camera, a 3D camera, an infrared sensor, a temperature sensor, a humidity sensor, a barometric sensor, an air quality sensor, a particulate sensor, a motion sensor, a microphone, or combinations thereof.

3. The sensor system of claim 1, wherein the system includes an antenna operably coupled to the SOC for wirelessly transmitting the at least one control signal.

4. The sensor system of claim 3, wherein the antenna is configured to transmit the at least one control signal to a system controller for a building system.

5. The sensor system of claim 4, wherein the building system comprises ventilation, heating, cooling, lighting, security, occupancy monitoring, air quality, humidity, or combinations thereof.

6. The sensor system of claim 1, wherein the SOC is wired to a system controller for a building system for transmitting the at least one control signal to the system controller.

7. The sensor system of claim 1, further comprising:
a gang box having an exterior wall defining an enclosed space and an opening through the exterior wall for accessing the enclosed space;
a light switch having a switch feature and a switch box, the light switch being positioned within the opening such that the switch box is positioned within the enclosed space and the switch feature protrudes from the opening; and
a light switch cover mountable to the gang box to cover the opening.

8. The sensor system of claim 7, wherein the exterior wall includes at least one mounting feature for mounting the gang box to a support structure.

9. The sensor system of claim 7, wherein the gang box defines an opening through which wiring can be inserted to operably couple the light switch box to the wiring.

10. The sensor system of claim 9, wherein the SOC can be positioned within the enclosed space such that the SOC can be operably coupled to the wiring;
wherein the remote sensor is operably coupled to the SOC such that the SOC powers the remote sensor.

11. The sensor system of claim 7, wherein the switch feature is selected from a group consisting of a conventional toggle switch, but can comprise a push button, a dimmer switch, a slider switch, a touch screen, and a button switch.

12. The sensor system of claim 7, wherein the light switch cover defines at least one remote sensor port;
wherein the remote sensor is coupled to the light switch cover adjacent the remote sensor port.

13. The sensor system of claim 12, wherein a semi-transparent window pane positioned within the remote sensor port preventing contaminants from entering the enclosed space.

14. The sensor system of claim 7, wherein the antenna is mounted to the light switch cover.

15. A method for monitoring a building, the method comprising:
positioning a remote sensor within an area of the building;
taking at least one measurement with the remote sensor;
receiving the at least one measurement from the remote sensor with a SOC; and
calculating at least one control signal with the SOC based on the at least one measurement from the remote sensor.

16. The method of claim 15, wherein the remote sensor comprises an optical camera, a 3D camera, an infrared sensor, a temperature sensor, a humidity sensor, a barometric sensor, an air quality sensor, a particulate sensor, a motion sensor, a microphone, or combinations thereof.

17. The method of claim 16, further comprising:
taking at least one first measurement of a first type with a first sensor; and
taking at least one second measurement of a second type with a second sensor.

18. The method of claim 17, further comprising:
receiving the at least one first measurement from the first sensor and the at least one second measurement from the second sensor with the SOC; and
calculating at least one control signal with the SOC based on the at least one first measurement and the at least one second measurement.

19. The method of claim 15, further comprising:
coupling an antenna to the SOC; and
transmitting the at least one control signal.

20. The method of claim 19, wherein the at least one control signal is transmitted to a system controller for a building system.

21. The method of claim 20, wherein the building system comprises ventilation, heating, cooling, lighting, security, occupancy monitoring, air quality, humidity, or combinations thereof.

22. The method of claim 15, further comprising:
positioning a second remote sensor of a second sensor system within a second area of the building; and
taking at least one second measurement with the second remote sensor.

23. The method of claim 22, further comprising:
transmitting the at least one measurement from the remote sensor to the second sensor system; and
receiving the at least one second measurement from the second sensor system with the SOC.

24. The method of claim 23, further comprising:
calculating at least one control signal with the SOC based on the at least one measurement from the remote sensor and the at least one second measurement from the second remote sensor.

25. A sensor system for a building, comprising:
a remote sensor configured to take at least one measurement within an area of the building;
a system on a chip (“SOC”) configured to receive the at least one measurement from the remote sensor; and
a controller configured to read computer readable instructions and configured to control operation of the sensor system, wherein the instructions for controlling operation of the sensor system comprises instructions for:
receiving the at least one measurement from the remote sensor with a SOC; and
calculating at least one control signal with the SOC based on the at least one measurement from the remote sensor.
